(19) United States
(12) Patent Application Publication
(10) Pub. No.: US 2010/0251597 A1
(43) Pub. Date: Oct. 7, 2010

(54) Roman's movable fishing lure

(76) Inventors: Yuriy Yatsenko, Philadelphia, PA (US); Roman Pankiv, Philadelphia, PA (US)

Correspondence Address: Aleksandr Smushkovich, POB 140505, Brooklyn, NY, 11214, US

(21) Appl. No.: 12/384,572

(22) Filed: Apr. 7, 2009

(51) Int. Cl. A01K 85/00

(52) U.S. Cl. 43/26.2; 43/42.35

(57) ABSTRACT

An artificial lure for fishing comprises a hollow body fillable with compressed air, an intake valve for inlet of compressed air therein, a rotatable tail, a joint unit connecting the body with the tail, and a discharge unit. The joint unit includes a front elastic bushing secured in the body, a rear elastic bushing secured in the tail, two hollow members respectively secured in the front and rear bushings, forming a common cylinder, a string fixed to the first member, a stud coupled to the string and to a washer supported by a nut screwed on the stud, a spring fixed to the first member and to the washer. The discharge unit includes a front pipe communicated to the body and a rear pipe providing outlet of compressed air into the surrounding water at a predetermined angle of turning the tail around the central longitudinal axis of the lure.

### FIELD OF THE INVENTION

The invention relates to the field of fishing devices, particularly to artificial movable lures.

### BACKGROUND OF THE INVENTION

There are known many different devices for fishing that utilize artificial lures. For instance, U.S. Pat. No. 6,430,867 teaches: “A directionally controllable fishing lure enables an angler to cast the lure to a desired area, with the lure traveling an arcuate path to the left or right upon retrieval. The direction of turn is determined by the angler, depending upon the rigging of the lure. The present lure has an elongate body with angularly truncated faces at each end thereof. The two faces are angled in opposite directions to one another, and the lure body is ballasted so that the two faces are always angled to one side when the lure is floating in the water, rather than facing upwardly or downwardly. The angularly truncated ends produce an asymmetrical hydrodynamic reaction as the lure is drawn through the water, causing the lure to turn in one direction or the other. If the angler attaches the fishing leader or line to the first end, the lure will travel in an arcuate path to the angler's right (or to the left, when considered in the direction of travel of the lure). Attaching the line or leader to the opposite end, results in a turn in the opposite direction. Thus, the present lure may be made to work around snags, weeds, and other obstructions, and/or may be made to work upstream in a current. The arcuate retrieve path is also much more realistic than the straight retrieval path of other lures, thus attracting fish more readily due to the realistic travel path of the present lure.”

Another U.S. Pat. No. 5,355,613 discloses “A fishing lure is described containing a cast of a natural bait encased in a castable transparent material designed in hydrodynamically correct shapes and to operate at different depths by utilizing an adjustable buoyancy device. A cast of a natural bait being the embodiment of a natural bait in the form of a castable material taken from the cast of a natural bait and then painted, to which an adjustable buoyancy device is incorporated by containment within the lure or attachment to the lure of a sealed air chamber wherein the adjustable portion consists of a cylinder which is threaded on the inside to accommodate a set screw/gasket seal combination. Rotation of the set screw varies the lure's buoyancy by compressing the air in the air chamber thus varying the fluid displacement volume of the lure and also changing the center of gravity of the lure.”

Yet, another U.S. Pat. No. 6,430,867 describes: “A fishing lure apparatus for plug or spin casting has an elongated body having a swivel shank on the front for attaching a fishing line and a spring clasp on the rear for attaching interchangeable tail portions. The elongated body has a hollowed-out belly having a slidable mass therein which in one position maintains the lure with air entrapped in the hollowed-out portion, so that the lure floats on the surface and in a second position, tilts the lure to let the air escape so that the lure dives. An adjustable wobble plate or lip helps control the depth of the dive and the wobble of the lure. A sliding belly cover to cover a portion of the opening to the hollow belly portion may be used to provide additional weight and better air entrapment.”

The above mentioned relevant art devices have an advantage of control of their movement in water, particularly due to employing hollow members. However, they are complicated, and hence expensive to produce.

The primary aim of the present invention is to essentially reduce production costs and provide an efficient artificial lure for fishing. Other purposes of the invention might become apparent to a skilled artisan upon learning the present disclosure.

### BRIEF SUMMARY OF THE INVENTION

The mentioned aim is achieved by providing an inventive artificial lure, which lure in a preferred embodiment comprises: an elongated hollow body preferably having a fish-like shape and preferably made of metal; an intake valve preferably disposed in the head region of the hollow body for inlet of compressed air therein; an artificial tail, a joint unit that connects the rear part of hollow body with the tail, so that the tail keeps its position after it's been turned at a predetermined angle, the joint unit is disposed partially in the hollow body portion and partially in the tail portion; and a discharge unit disposed partially in the hollow body and partially in the tail for controllable outlet of compressed air from the hollow body.

It is desirable to provide the hollow body with an artificial caudal fin attached to the tail, a dorsal (spinal) fin, an abdominal fin, etc. to imitate a natural fish look. It is preferable to make the fins of suitable synthetic material, and to color them in orange and black.

A fisherman sets the discharge unit into the closed state by turning the tail into an ‘off’ position, then pumps compressed air into the hollow body through the intake valve. Initially, the tail may be aligned at a BETA angle (e.g. to the right, preferably at 90 degrees) to a vertical plane extending through the longitudinal axe of the hollow body being in the ‘off’ position, to insure that the compressed air would not discharge through the discharge unit, and it would be tightly closed.

Before casting, the fisherman turns the tail at a predetermined ALPHA angle (preferably about 15 degrees, e.g. to the left) relatively to the vertical plane extending through the longitudinal axe of the hollow body, and thereby places the tail into an ‘on’ position that opens the discharge unit to outlet the compressed air from the hollow body, and thereafter casts the lure into water. Since the compressed air outlets from the discharge unit till its pressure is higher than the surrounding pressure of water, creating a jet, and the tail is turned at the predetermined angle ALPHA, the lure will be moving substantially along a curve (probably close to a spiral line, since the pressure of the outlet air is gradually decreasing), but not straight. This curved movement looks more natural than a straight linear movement that would likely attract more fish.

Different conventional means can be used to inlet compressed air into the hollow body, for example, a regular bicycle pump, or a foot-driven pump, etc., having special adaptors for connection with the intake valve.

According to a preferred embodiment of the present invention, a special compressed air vessel could be conveniently used to store compressed air, to pump compressed air into the vessel, and to output compressed air from the vessel into the intake valve of the hollow body. The vessel includes a sufficiently sturdy container capable to keep air under a predetermined pressure higher than the atmosphere pressure, a hand pump incorporated into the body of container, and an output valve incorporated into the body of container and having an adaptor member connectable to the intake valve of the hollow body of lure.

According to preferred embodiments of the present invention, the lure is furnished with a float linked with the hollow body. The float has an alarm unit placed therein and producing an alarm signal when the lure is taken by fish. The float is preferably made of suitable plastic. A phosphorescent strip can be attached (e.g. glued) to the hollow body, mostly usable for night fishing or in deep water. The inventive lure is furnished with a hook, and is preferably supplied with a number of loops usable for attachment of triple-hooks for catching large fish.

### DESCRIPTION OF DRAWINGS

FIG. 1 illustrates a general sectional view of the lure and fragmental rear views (VV-1 and VV-2) for the ‘off’ and ‘on’ positions of its tail, according to a preferred embodiment of the inventive lure.

FIG. 2 illustrates a compressed air vessel usable for pumping, storage, and inlet of compressed air into the hollow body of the lure, according to a preferred embodiment of the present invention.

FIG. 3 illustrates a detail sectional view of the tail part of the lure with the joint unit, according to a preferred embodiment of the present invention.

FIG. 3a illustrates a detail sectional view of the joint unit in the ‘off’ position, according to a preferred embodiment of the present invention.

FIG. 3b illustrates a detail sectional view of the joint unit in the ‘on’ position, according to a preferred embodiment of the present invention.

Each reference numeral indicated on the aforementioned drawings is designated to an element of the inventive lure described herein below. A first time introduced reference numeral in the description is enclosed into parentheses.

### DETAIL DESCRIPTION OF A PREFERRED EMBODIMENT OF THE INVENTION

While the invention may be susceptible to embodiment in different forms, there is shown in the drawing, and will be described in detail herein, a specific embodiment of the present invention, with the understanding that the present disclosure is to be considered an exemplification of the principles of the invention, and is not intended to limit the invention to that as illustrated and described herein.

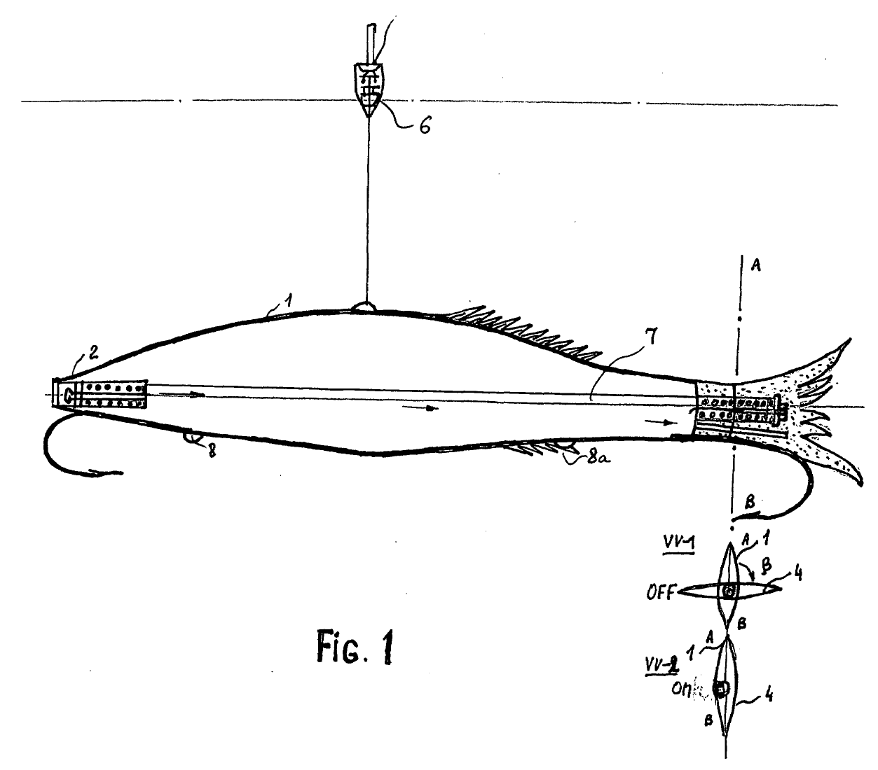

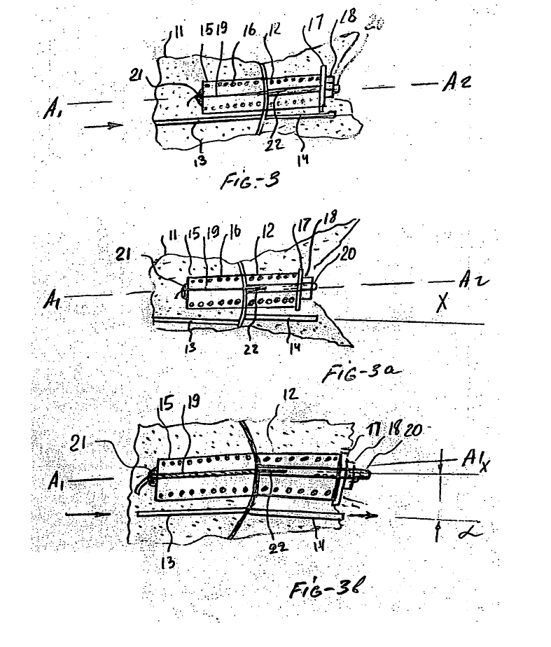

In a preferred embodiment illustrated on FIGS. 1, 3, 3a and 3b, the inventive lure comprises: an elongated hollow body (1) preferably having a fish-like shape and preferably made of metal; an intake valve (2) disposed preferably in the head portion of the hollow body 1 for inlet of compressed air therein; an artificial tail (4) flexibly and turnably attached to the rear part of hollow body 1; and a joint unit (3) disposed partially in the hollow body's rear portion and partially in the tail; and a discharge unit for controllable outlet of compressed air from the hollow body, the discharge unit is disposed partially in the hollow body's rear portion and partially in the tail.

As shown on FIG. 3, the joint unit 3 comprises a front bushing (11) made of suitable elastic material, e.g. plastic or rubber. The front bushing 11 fills the rear portion of the hollow body 1 and fixedly secured to the hollow body. The joint unit 3 comprises a rear bushing (12) made of suitable elastic material, e.g. plastic or rubber. The bushing 12 is fixedly secured in the front portion of the tail 4. The bushing 12 is capable of angular rotational movement relatively to the bushing 11, essentially around the central longitudinal axis A1-A2 of the lure, while the bushings stay joined with each other.

The joint unit 3 comprises a front hollow cylinder member (15) fixedly secured in the bushing 11, essentially along the central longitudinal axis A1-A2 of the lure, and having a base (at the left end, as shown on FIG. 3) and an opening (at the right end, as shown on FIG. 3) facing the tail 4. The joint unit 3 comprises a rear hollow cylinder member (21) fixedly secured in the bushing 12, essentially along the central longitudinal axis A1-A2 of the lure, and having a front opening (at the left end, as shown on FIG. 3) facing the hollow body 1 and a rear opening (at the right end, as shown on FIG. 3). The opening of cylinder member 15 and the front opening of cylinder member 21 coincide so that the members are forming a common cylinder; however the member 21 has a freedom of rotation around the axis A1-A2, relatively to the immovable member 15.

The joint unit 3 comprises a spring (16) that is contractedly preloaded and tends to expand. A first (e.g. left, as shown on FIG. 3) end of the spring 16 is fixed (e.g. soldered) to the base of front cylinder member 15. The joint unit 3 comprises a string (19) and a thin stud (20) with a screw threading. The string 19 is fixed (e.g. soldered) to the base of front cylinder member 15 with its first (e.g. left, as shown on FIG. 3) end, and to the stud 20 with its second (e.g. right, as shown on FIG. 3) end. A nut (18) is screwed on the stud 20 supporting a washer (17) disposed neat the rear opening of cylinder member 21. A second (e.g. left, as shown on FIG. 3) end of the spring 16 is fixed to the washer 17.

The joint unit 3 thus serves to join the hollow body 1 with the tail 4 by means of the string 19, while it allows turning the tail relatively to the vertical plane extending through the longitudinal axis of hollow body (essentially to the left and to the right) and fixation the tail at a certain angle due to the spring 16 and the cylindrical members 15 and 21.

The discharge unit comprises a front pipe (13) secured in the bushing 11. The pipe 13 has a first end connected to the interior of hollow body 1 filled with compressed air, and a second end terminated with an opening facing the tail. The discharge unit comprises a rear pipe (14) secured in the bushing 12. The pipe 14 has a first end terminated with an opening that faces the hollow body 1, and a second end with an opening that provides outlet of the compressed air into the surrounding water.

The second end of pipe 13 and the first end of pipe 14 can coincide substantially at a predetermined angle ALPHA of turning the tail 4 (along an axis ‘x’ shown on FIGS. 3a and 3b), which corresponds to the ‘on’ position (shown on FIG. 3b). At other angular positions of the tail (e.g. shown on FIG. 3a), the second end of pipe 13 and the first end of pipe 14 cannot coincide, so that the discharge unit does not outlet the compressed air from the hollow body 1.

In preferred embodiments, the angle ALPHA may be chosen substantially equal to 15 degrees. Therefore the fisherman can control the discharge of compressed air from the hollow body of lure by turning the tail into any ‘off’ positions (e.g. as shown on FIG. 1 view VV-1 and on FIG. 3a) and into the only one ‘on’ position (also shown on FIG. 1 view VV-2 and on FIG. 3b) corresponding to the angle ALPHA.

### Operation of the Preferred Embodiment

A fisherman sets the discharge unit into the closed state by turning the tail 4 into an ‘off’ position, then pumps compressed air into the hollow body 1 through the intake valve 2. Initially, the tail 4 may be aligned at any BETA angle (e.g. to the right, preferably at 90 degrees) to the vertical plane extending through the longitudinal axe of the hollow body 1 being in the ‘off’ position, to insure that the compressed air would not discharge through the discharge unit, and it would be tightly closed.

Before casting, the fisherman turns the tail 4 at the predetermined ALPHA angle (preferably about 15 degrees, e.g. to the left) relatively to the vertical plane extending through the longitudinal axe A1-A2 of the hollow body 1, and thereby places the tail into an ‘on’ position that opens the discharge unit to outlet compressed air from the hollow body 1, and thereafter casts the lure into water. Since compressed air outlets from the discharge unit till its pressure is higher than the surrounding pressure of water, creating a jet, and the tail 4 is turned at the predetermined angle ALPHA, the lure will be moving substantially along a curve (probably close to a spiral line, since the pressure of the outlet air is gradually decreasing), but not straight.

### Optional Embodiments of the Invention

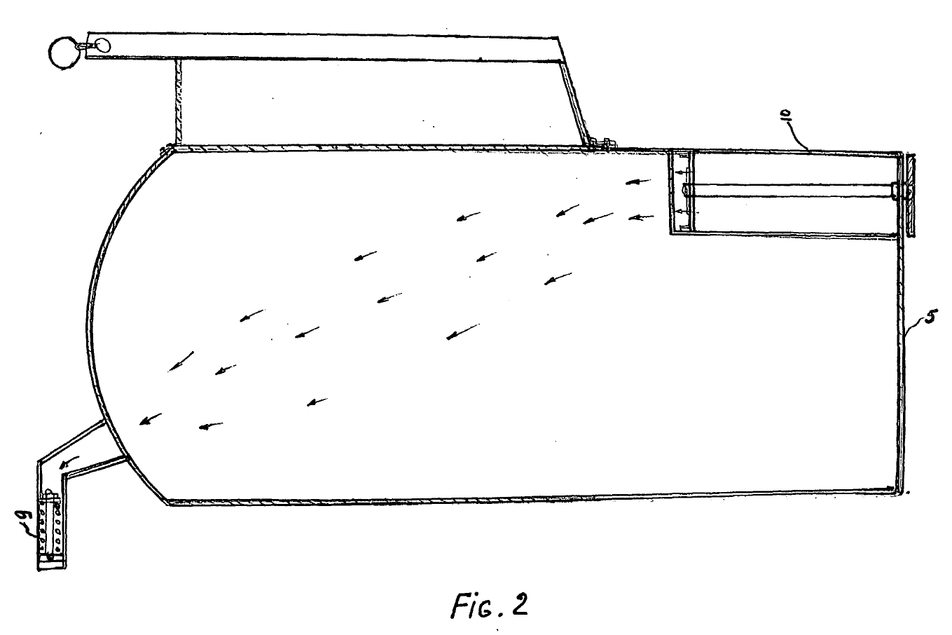

Different conventional means can be used to inlet compressed air into the hollow body 1, for example, a regular bicycle pump having a special adaptor for connection with the intake valve. According to a preferred embodiment of the present invention, a special compressed air vessel (shown on FIG. 2) could be conveniently used to store compressed air, to pump the compressed air into the vessel, and to output the compressed air from the vessel into the intake valve 2 of the hollow body 1. The vessel includes a sufficiently sturdy container (5) capable of keeping air under a predetermined pressure higher than the atmosphere pressure, a hand pump (10) incorporated into the container 5, and an output valve (9) incorporated into the container 5 and having an adaptor member (not shown) connectable to the intake valve 2.

According to preferred embodiments of the present invention shown on FIG. 1, the lure is furnished with a float (6) linked with the hollow body 1, having an alarm unit (not shown) placed therein and producing an alarm signal when the lure is taken by fish. The float 6 is preferably made of suitable plastic. A phosphorescent strip (7) can be attached (e.g. glued) to the hollow body 1, mostly usable for night fishing or in deep water. The inventive lure is furnished with a hook (8), and can be supplied with a number of loops (8a) usable for attachment of triple-hooks (not shown) for catching large fish.

In alternative embodiments, the joint unit and the discharge unit can be differently designed, but should provide the same functionality. In some embodiments (not shown), the turning of the tail relatively to the hollow body can be provided remotely that would require a rotational means (e.g. a preloaded spring, or a suitable motor with a power source, etc.) to be installed on the lure, which rotational means should wiredly or wirelessly communicate with a monitoring unit controlled by the fisherman.

We claim:

1. An artificial lure for fishing comprising:
a hollow body;
an intake valve associated with said hollow body for inlet of compressed air therein;
a tail;
a joint means for connecting the rear part of said hollow body with said tail; and
a discharge means for outlet of compressed air from said hollow body substantially through said tail.

2. The lure according to claim 1, additionally furnished with a float linked to said hollow body, said float encloses an alarm means for producing an alarm signal when said lure is taken by fish.

3. The lure according to claim 1, additionally furnished with a phosphorescent strip attached to said hollow body.

4. A combination of the lure according to claim 1 with a vessel means for storage, pumping, and output of compressed air into the hollow body of said lure.

5. An artificial lure for fishing comprising:
a hollow body fillable with compressed air;
an intake valve associated with said hollow body for inlet of compressed air therein;
a tail;
a joint means for connecting the rear part of said hollow body with said tail; and
a discharge means for controllable outlet of compressed air from said hollow body substantially through said tail.

6. The artificial lure according to claim 5, wherein:
said joint means including
a front elastic bushing filling the rear portion of said hollow body and immovably secured therein;
a rear elastic bushing secured in the front portion of said tail, said rear bushing capable of angular rotational movement around a central longitudinal axis of said lure and relatively to said front bushing;
a front hollow cylinder member fixedly secured in said front bushing, essentially along the central longitudinal axis of said lure, and having a base and an opening facing said tail;
a rear hollow cylinder member fixedly secured in said rear bushing essentially along the central longitudinal axis of said lure, said rear cylinder member having a front opening facing said hollow body and a rear opening, said front opening coincides with the opening of said front cylinder member so that the cylinder members forming a common cylinder;
a spring being contractedly preloaded and tending to expand, having a first end fixed to the base of said front cylinder member, and having a second end;
a string and a stud with a screw threading, said string is fixed to the base of said front cylinder member with its first end, and to the stud with its second end;
a nut screwed on the stud and supporting a washer disposed near the rear opening of said rear cylinder member, said washer is fixed to said second end of the spring;
said discharge means including
a front pipe secured in said front bushing, said front pipe having a first end connected to the interior of said hollow body and a second end terminated with an opening facing the tail;
a rear pipe secured in said rear bushing, said rear pipe having a first end terminated with an opening that faces the hollow body, and a second end with an opening that provides outlet of compressed air into the surrounding water;
wherein the second end of said front pipe and the first end of said rear pipe coincide substantially at a predetermined angle of turning said tail around the central longitudinal axis of said lure.
